(19) United States
(12) Patent Application Publication
(10) Pub. No.: US 2013/0219418 A1
(43) Pub. Date: Aug. 22, 2013

(54) APPARATUS AND METHOD FOR CHANGING FAST CHANNEL BASED ON SVC IN MULTICAST MOBILE IPTV SERVICE

(71) Applicant: Hyun-Suk ROH, Daejeon-si (KR)

(72) Inventor: Hyun-Suk ROH, Daejeon-si (KR)

(73) Assignee: Electronics and Telecommunications Research Institute, Daejeon-si (KR)

(21) Appl. No.: 13/586,195

(22) Filed: Aug. 15, 2012

(30) Foreign Application Priority Data
Feb. 22, 2012 (KR) 10-2012-0018139

(51) Int. Cl. H04N 21/442

(52) U.S. Cl. 725/14

(57) ABSTRACT

A method of selecting a predicted channel in mobile IPTV services by an expected channel selection function (ECSF) device linked with a gateway is provided. The method includes acquiring channel connection history information of a terminal user, selecting a channel predicted to be connected next by the terminal user in accordance with the acquired channel connection history information, and setting a bearer of the selected channel.

### CROSS-REFERENCE TO RELATED APPLICATION

This application claims the benefit under 35 U.S.C. §119(a) of Korean Patent Application No. 10-2012-0018139, filed on Feb. 22, 2012, the entire disclosure of which is incorporated herein by reference for all purposes.

### BACKGROUND

1. Field

The following description relates to a mobile IPTV system, and more particularly, to a scalable video coding (SVC) multimedia image service apparatus and method in multicast services.

2. Description of the Related Art

Scalable video coding (SVC) is technology in which a single image is used as a basic layer to which a plurality of high order layers are added in order to improve video quality. In the conventional technology, images of additional display windows with respect to broadcast services are first output as the basic layer, and then high order layers are output, thereby reducing a channel changing time.

Until now, changing from one channel to another takes a lot of time due to signaling and traffic transmission for service reception.

### SUMMARY

The following description relates to an apparatus and method for enabling services to be provided at a high speed when a mobile terminal changes a channel in a multicast mobile IPTV (Internet protocol television) system.

The following description relates to an apparatus and method for performing a join procedure in advance with respect to the next channel list to be expected in accordance with a channel changing pattern of a mobile IPTV user, thereby minimizing a time required for channel changing.

In one general aspect, there is provided an expected channel selection function (hereinafter, referred to as “ECSF”) device in mobile IPTV services, including: a user identification (ID) information acquisition unit that acquires user ID information of a terminal requesting the mobile IPTV service to be provided; a channel connection history information database (DB) for each user that stores channel connection history information of at least one user to be provided with the mobile IPTV service; a user history information search unit that searches for the channel connection history information corresponding to the user ID information acquired by the user ID information acquisition unit; a channel selection unit that selects a channel predicted to be connected next by the user in accordance with the channel connection history information searched by the user history information search unit; and a bearer setting unit that sets a bearer of the channel selected by the channel selection unit.

In another general aspect, there is provided a method of selecting a predicted channel in mobile IPTV services by an ECSF device linked with a gateway, the method including: acquiring channel connection history information of a terminal user; selecting a channel predicted to be connected next by the terminal user in accordance with the acquired channel connection history information; and setting a bearer of the selected channel.

Other features and aspects will be apparent from the following detailed description, the drawings, and the claims.

### BRIEF DESCRIPTION OF THE DRAWINGS

FIG. 1 is a configuration diagram illustrating a multicast broadcast service (MBS) system to which the present invention is applied;

FIG. 2 is a detailed configuration diagram illustrating a predicted channel selection device according to a preferred embodiment of the present invention;

FIG. 3 is a flowchart illustrating a method of selecting a predicted channel in accordance with driving of terminal power according to a preferred embodiment of the present invention; and

FIG. 4 is a flowchart illustrating a method of selecting a predicted channel according to a preferred embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

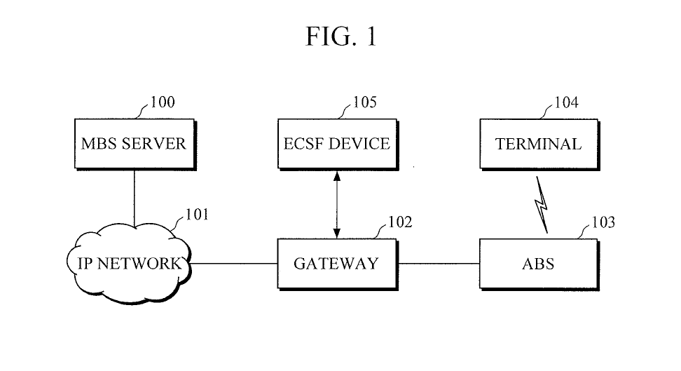

FIG. 1 is a configuration diagram illustrating a multicast broadcast service (hereinafter, referred to as “MBS”) system to which the present invention is applied.

Referring to FIG. 1, an MBS server 100 is linked with a content server (not shown) to provide multicast and broadcast services, and performs user terminal management including session setting and transmits multimedia traffic acquired from the content server to a terminal 104 through an IP network 101, a gateway, and an advanced base station 103 (hereinafter, referred to as “ABS”).

The gateway 102 receives the multimedia traffic transmitted through the IP network 101, transmits the received multimedia traffic to the ABS 103, and internally performs termination service in response to a multicast service request.

According to the present invention, the gateway 102 is linked with an expected channel selection function (hereinafter, referred to as “ECSF”) device 105, and permits a bearer with other channels to be predicted to be set before the terminal 104 changes a channel by a control of the ECSF device 105.

The base station 103 transmits the multimedia traffic received through the gateway 102 to the terminal 104 through a wireless interface.

The ECSF device 105 stores a history with respect to IPTV channel selection of terminal 104 users, predicts a channel to be selected next by the user based on information about the stored history, and performs bearer setting of the predicted channel to thereby transmit basic layer information of a corresponding channel to the terminal 104.

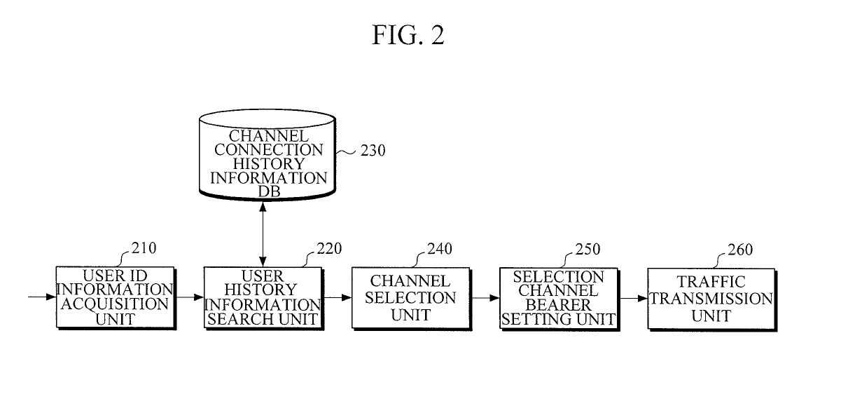

FIG. 2 is a detailed configuration diagram illustrating an ECSF device according to a preferred embodiment of the present invention.

Referring to FIG. 2, the ECSF device 105 includes a user identification (ID) information acquisition unit 210, a user history information search unit 220, a channel connection history information database (DB) 230 for each user, a channel selection unit 240, a selection channel bearer setting unit 250.

The user ID information acquisition unit 210 acquires user ID information which is transmitted from a terminal requesting service connection in accordance with power driving, that is, user ID, and outputs the acquired user ID.

The user history information search unit 220 searches for a channel connection history corresponding to the user ID acquired by the user ID information acquisition unit 210 from the channel connection history information DB 230.

The channel selection unit 240 selects a channel predicted to be connected next by the user in accordance with channel connection history information of a corresponding user which is searched by the user history information search unit 220.

The selection channel bearer setting unit 250 controls a bearer of the channel selected by the channel selection unit 240 to be set in advance.

A traffic transmission unit 260 transmits a basic layer of scalable video coding (SVC) to the corresponding terminal 104 through the channel whose bearer is set.

In this manner, when selecting a corresponding channel by the terminal 104 in a state in which the bearer is set, the terminal may rapidly output a basic layer of the corresponding channel which is received.

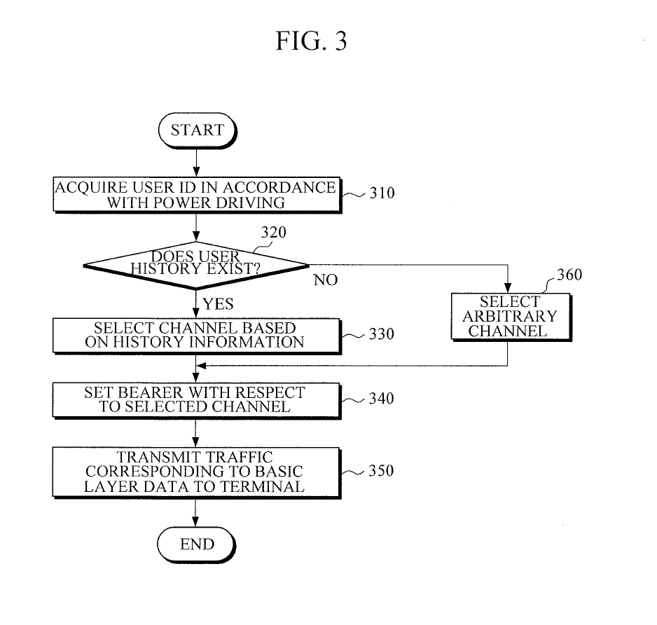

FIG. 3 is a flowchart illustrating a method of selecting a predicted channel in accordance with driving of terminal power according to a preferred embodiment of the present invention.

Referring to FIG. 3, in operation 310, the ECSF device acquires a user ID in accordance with power driving of the terminal.

In operation 320, the ECSF device determines whether user channel connection history information corresponding to the user ID exists.

In operation 330, when the history information exists based on the determination result of operation 320, the ECSF device selects the next predicted channel based on the history information.

In operation 360, when the history information does not exist based on the determination result of operation 320, the ECSF device selects an arbitrary channel.

In operation 340, the ECSF device selects a bearer with respect to the selected channel.

In operation 350, the ECSF device permits traffic corresponding to basic layer data to be transmitted to the terminal through the channel whose bearer is set.

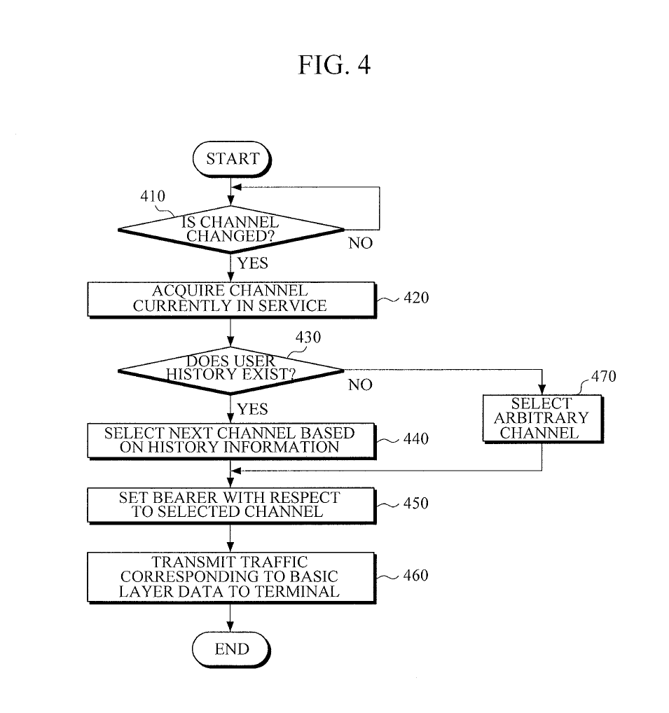

FIG. 4 is a flowchart illustrating a method of selecting a predicted channel according to a preferred embodiment of the present invention.

Referring to FIG. 4, in operation 410, the ECSF device determines whether a channel is changed. That is done to select a channel predicted to be changed next in accordance with the change in the channel.

In operation 420, when the channel is changed based on the determination result of operation 410, the ECSF device acquires information on a channel currently in service.

In operation 430, the ECSF device determines whether user channel connection history information corresponding to a user ID exists.

In operation 440, when the history information exists based on the determination result of operation 430, the ECSF device selects the next predicted channel based on the history information. That is, the ECSF device selects a channel adjacent to the channel which is currently in service.

In operation 470, when the history information does not exist based on the determination result of operation 430, the ECSF device selects an arbitrary channel.

In operation 450, the ECSF device sets a bearer with respect to the selected channel.

In operation 460, the ECSF device permits traffic corresponding to basic layer data to be transmitted to the terminal through the channel whose bearer is set.

As described above, according to the embodiments, mobile IPTV services are provided using multicast services in a mobile network, and communication with a core network is performed so that a basic layer is output in advance with respect to the next channel to be predicted in advance based on a channel changing pattern of a mobile terminal, and therefore services are provided such that a channel is changed at a high speed with respect to multicast traffic.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An expected channel selection function (ECSF) device in mobile IPTV (Internet protocol television) services, comprising:
a user identification (ID) information acquisition unit that acquires user ID information of a terminal requesting the mobile IPTV service to be provided;
a channel connection history information database (DB) for each user that stores channel connection history information of at least one user to be provided with the mobile IPTV service;
a user history information search unit that searches for the channel connection history information corresponding to the user ID information acquired by the user ID information acquisition unit;
a channel selection unit that selects a channel predicted to be connected next by the user in accordance with the channel connection history information searched by the user history information search unit; and
a bearer setting unit that sets a bearer of the channel selected by the channel selection unit.

2. The ECSF device according to claim 1, wherein the user ID information acquisition unit acquires user ID information of a power-driven terminal.

3. The ECSF device according to claim 1, wherein the channel selection unit determines whether the history information exists.

4. The ECSF device according to claim 1, wherein the channel selection unit selects an arbitrary channel when the history information does not exist.

5. The ECSF device according to claim 1, wherein the channel selection unit selects, as the predicted channel, a channel adjacent to a channel which is currently in service on the terminal.

6. A method of selecting a predicted channel in mobile IPTV services by an ECSF device linked with a gateway, the method comprising:
acquiring channel connection history information of a terminal user;
selecting a channel predicted to be connected next by the terminal user in accordance with the acquired channel connection history information; and
setting a bearer of the selected channel.

7. The method according to claim 6, wherein the selecting of the channel includes selecting an arbitrary channel when the history information does not exist.

8. The method according to claim 6, wherein the selecting of the channel includes selecting, as the predicted channel, a channel adjacent to a channel which is currently in service on the terminal.
